(19) United States
(12) Patent Application Publication
(10) Pub. No.: US 2026/0084319 A1
(43) Pub. Date: Mar. 26, 2026

(54) MICRO CLEANING ROBOTS

(71) Applicant: Raytheon Company, Tewksbury, MA (US)

(72) Inventor: Laura J. Aguilar, Sherman, TX (US)

(21) Appl. No.: 18/891,568

(22) Filed: Sep. 20, 2024

(51) Int. Cl. B25J 11/00; B25J 5/00; B25J 19/00

(52) U.S. Cl. CPC B25J 11/0085; B25J 5/007; B25J 19/005

(57) ABSTRACT

A system for removing debris from one or more internal structures of a work piece including a robotic cleaner sized to fit within the one or more internal structures of the work piece. The robotic cleaner includes a robotic cleaner frame, two or more rotatable members coupled with the robotic cleaner frame and a debris collecting substrate coupled with at least one of the two or more rotatable members. The debris reducing substrate is configured to perform a debris collecting operation.

### BACKGROUND

Chassis structures that house, for example, mechanical, electronic or computer systems (or a combination of systems) are, at times, positioned in environments where the chassis structure is exposed to harsh environmental conditions. For example, chassis structure is located in environments where wind, water or temperature introduces external matter into interior components. Over time, chassis structures can accumulate undesired debris, dirt or other particulates, or liquids within internal structures.

For example, certain chassis structures can house systems that have internal structures, such as enclosed cavities, pathways, channels, tunnels, or the like that were formed during the building or manufacturing of the chassis structure. In other examples the internal structures protect the systems from the environment. The internal structures, while sometimes protective to the environment, can accumulate debris, dirt or particulate matter, or liquids (herein after “debris”). In some instances, the debris can cause damage to the systems. Damage to the systems, in some examples, causes the system to malfunction or be rendered nonfunctional.

Robots are programmable machines capable of carrying out complex actions automatically. Robots can be designed to autonomously perform operations or in other examples, robots are remotely controlled by humans. Autonomous robots can be programmed to follow specific routines, adapt to different environments, and safely interact surrounding equipment. In other examples, remotely controlled robots can access areas or perform operations that are difficult for humans to perform. Robots can also accomplish tasks that increase or improve efficiencies for actions otherwise performed by a human.

### SUMMARY

Cleaning the internal structures of chassis structure, at times, is challenging. For example, some chassis structure has access panels that are small relative to the size of the chassis structure and access to the internal structures is difficult for a human. For example, systems include internal structures that are a few centimeters wide and are accessible via a path of cavities, or openings. Specialized tools can be utilized to clean the internal structures. At times, the chassis structure is cleaned by a trained technician with skills or expertise related to the internal structures.

At times, conventional cleaning methods for these systems involves manual processes performed by trained technicians during scheduled maintenance intervals. During a maintenance procedure, the chassis structure can be opened, or accessed, exposing internal components, including sensitive components to contamination or damage. Even with maintenance, manual cleaning, at times, does not effectively reach all the internal structures that benefit from cleaning.

In an example, a system for removing debris from one or more internal structures of a piece of chassis structure benefits from autonomous or remote-controlled cleaning devices to access the internal structures. The cleaning devices can be sized to fit within the internal structures of the chassis structure. The cleaning devices, for example, include sensors or are remote-controlled to avoid contacting the internal structures in a manner that could cause damage to sensitive structures.

For instance, a system for removing debris from one or more internal structures of a work piece includes a robotic cleaner that is sized to fit within the one or more internal structures. The robotic cleaner can have at least one cleaning element. For example, the cleaning element is coupled with a rotatable member. In some instances, the rotatable member is a motive element that allows the robot to maneuver through the internal structures.

In examples with the cleaning element coupled to the rotatable, motive element, the cleaning element is a debris collecting substrate. The debris collecting substrate can include bristles, fabric, or other debris retaining material. For example, as the robotic cleaner maneuvers through the internal structures the cleaning element collects, attracts, retains or the like debris, such as particular matter, from the internal structures.

The robotic cleaner, in some examples, after completing a cleaning activity or reaching a termination point, returns to the portal in which it was inserted. A user can then optionally remove the debris collecting substrate, or the entire rotatable member, for cleaning. The user optionally can recharge the robotic cleaner in a charging structure. The charging structure, in some examples, also houses the robotic cleaners when not in use.

### BRIEF DESCRIPTION OF THE DRAWINGS

FIG. 1 illustrates an example of a robotic cleaner according to at least one example of the present disclosure.

FIG. 2 illustrates a schematic of a work piece according at least one example of the present disclosure.

FIG. 3A illustrates an example of a robotic cleaner according to at least one example of the present disclosure.

FIG. 3B illustrates an example of a close up of a cleaning element according to at least one example of the present disclosure.

FIG. 3C illustrates an example of a close up of a cleaning element according to at least one example of the present disclosure.

FIG. 4 illustrates an example of a schematic of a carrying case charging structure according to at least one example of the present disclosure.

FIG. 5 illustrates an example of a system for a retrieval system according to at least one example of the present disclosure.

FIG. 6 illustrates an example of a method of cleaning an internal structure of a work piece according to at least one example of the present disclosure.

### DETAILED DESCRIPTION

At times, maintaining and cleaning complex systems, such as chassis structures, electrical systems or the like, deployed in harsh environments presents challenges. For example, a work piece, such as chassis structure or electrical systems, includes internal structures that are small relative to the work piece. The small internal structures can be difficult to access or require specialized equipment to access. In other examples, the small internal structures present other challenges to maintaining and cleaning due to sensitive or delicate components within the internal structures.

In examples, conventional cleaning methods for work pieces with small internal structures involves manual processes performed by trained technicians using specialized tools. In certain situations, there are limited resources for technicians to use to clean or maintain the internal structures. In other situations, the work piece is located in an environment where access to internal structures is challenging. In other environments, the work piece is accessible but the internal structures house sensitive or delicate equipment that could be damaged or contaminated if exposed to environmental conditions.

Chassis structures can include mechanical systems, electronic systems, vehicles, defense system, computer system or the like (hereinafter “work piece”) that can accumulate debris, dirt or other particulates, or liquid (hereinafter “debris”) during operation, which can impair performance and reliability if not regularly removed. Cleaning or maintenance of these work pieces is sometimes irregularly preformed because of the complexity of the work piece. In some instances, the entire work piece is taken offline or moved to a different location for maintenance and cleaning. In other situations, the work piece is disassembled to clean or perform maintenance.

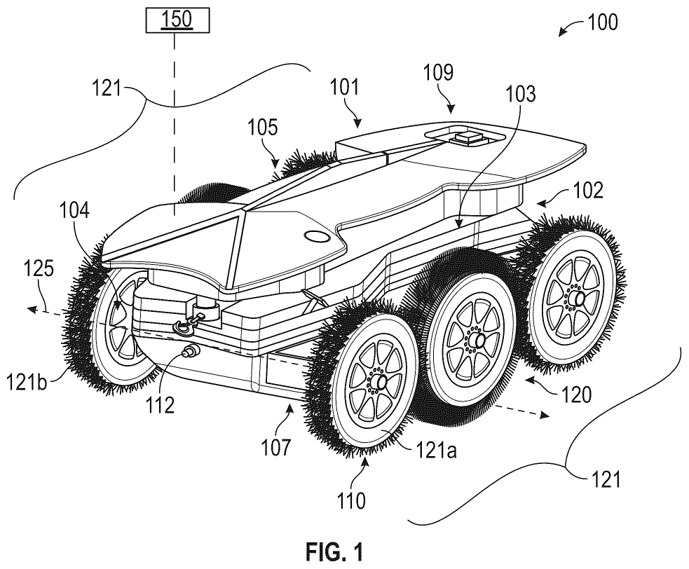

Illustrated in FIG. 1 is an example of an autonomous or cleaning device used to clean internal structures of a work piece. For instance, the cleaning device is a robotic cleaner sized to fit within internal structures of the work piece. For example, the robotic cleaner is sized to fit through an existing access portal on the work piece. The access portal (e.g., door, window, opening, panel or the like) can be an existing structure on a work piece that allows a user to gain access to internal structures for operation, while also providing an opening to insert a robotic cleaner.

The work piece can be structures such as electronic systems such as server racks or data centers, radar systems, pipelines, medical systems, vehicles (including aerospace, terrestrial or marine) or the like. In some instances, these work pieces include wiring or delicate components that if contacted by cleaning or maintenance tools could be damaged or made defective. In other examples, the work piece can include small internal structures relative to the size of the work piece. For instance, the internal structures have clearances of a few centimeters in width, height or depth. The cleaning device illustrated in FIG. 1 is designed to fit within the small internal structures while also sized and shaped to avoid damaging the internal components.

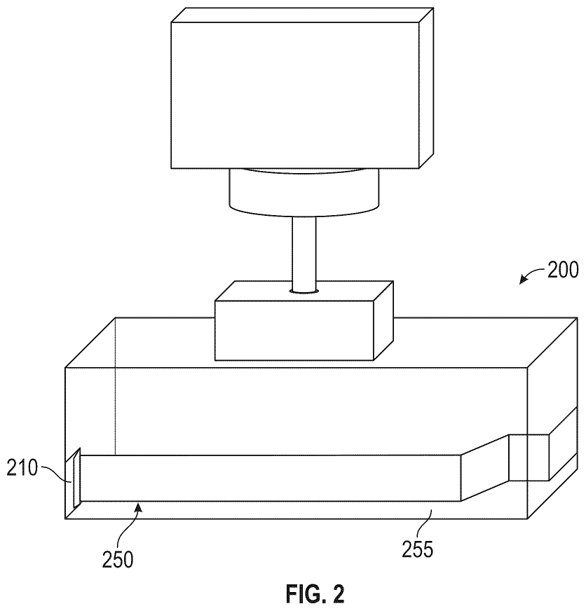

The robotic cleaner 100 can include autonomous or a remote-controlled robotic device designed to be inserted and fit through an access portal 210 of a work piece 200 (as illustrated in FIG. 2) to remove debris (e.g., dirt, dust, sand, droppings or other small particulate matter) from the internal structures within the work piece. The robotic cleaner 100 can be a small autonomous device designed to clean small (e.g., confined, tight, compact, narrow or the like) internal structures 250 within the work piece 200, as illustrated in FIG. 2. For example, the robotic cleaner 100 is sized to clean small internal structures 250 such as channels, pathways, cavities, tunnels or the like.

Returning to FIG. 1, the robotic cleaner 100, for example, is a microrobot. A microrobot can be, for example, a robotic device that can move through internal structures 250 of a work piece 200 (as illustrated in FIG. 2). For instance, the cleaning device as a microrobot has robotic cleaner body 101 a maximum width, length or both width and length of between approximately 1.0 centimeter and approximately 20.0 centimeters. In other examples, the cleaning device has a maximum width, length or both width and length of between approximately 1.0 centimeters and approximately 10.0 centimeters. In yet other examples, the cleaning device has a has a maximum width, length or both width and length of between approximately 1.0 centimeters and approximately 3.0 centimeters. The dimensions or profile of the cleaning device can be dictated according to the purpose and the dimensions of the internal structures.

The robotic cleaner body 101 can include a robotic cleaning frame 102. The robotic cleaner body 101 can be formed from a plastic, polymer, metallic, or a combination of materials. The material used for the robotic cleaner body 101 can be painted or formed from a material that glows or is readily noticeable in the internal structures. The robotic cleaning frame 102, for example is formed from a material that is supportive of the one or more cleaning elements 110, a power source 104, one or more motive elements 120 one or more cleaning elements, and other components coupled with the robotic cleaning frame 102.

For example, the robotic cleaner 100 includes one or more motive elements 120. The one or more motive elements 120 can be positioned on or coupled to the robotic cleaning frame 102. For example, two motive elements 120 are rotatable members with a first rotatable member 121a, such as a wheel, positioned on a first side portion 103 of the robotic cleaner body 101 and a second rotatable member 121b, such as another wheel, positioned on a second side portion 105. The one or more motive elements 120 can be positioned to provide mobility for the robotic cleaner 100. For example, the one or more motive elements 120 moves the robotic cleaner 100 along surfaces 255 within the internal structures 250 (of FIG. 2). In some instances, the one or more motive elements 120 includes wheels, tracks, or other components that move the robotic cleaner 100 through the internal structures.

The one or more motive elements 120 can be one or more rotatable members 121 that each rotate around, for example, an axis 125. In another example, the one or more motive elements 120 can be one or more rotatable member 121 that includes a track that rotates around two separate rotatable members. In one example, the robotic cleaner 100 includes one or more motive elements 120 on a first side portion 103 of the robotic cleaning frame 102 and one or more motive elements 120 on a second side portion 105 of the robotic cleaning frame 102. For instance, the one or more motive elements 120 includes a first wheel 121a coupled with the first side portion 103 and a second wheel 121b coupled with the second side portion 105 where the second side portion 105 is an opposite side of the robotic cleaning frame 102 relative to the first side portion 103. In another example, there is more than one first wheel 121a and more than one second wheel 121b each coupled to a respective first side portion 103 and second side portion 105. As illustrated in FIG. 1, the robotic cleaner 100 includes at least three first wheel 121a on the first side portion 103 and at least three second wheel 121b on the second side portion 105.

The first wheel 121a and the second wheel 121b can work cooperatively to maneuver then robotic cleaner 100 through the internal structures of the work piece. The first wheel 121a and the second wheel 121b, as one or more motive elements 120, can provide locomotion or mobility to the robotic cleaner 100. In some examples, the one or more motive elements 120 move the robotic cleaner 100 along surfaces of the work piece, such as floors, walls or ceilings or the like.

The robotic cleaner 100 can include one or more sensors 112. The one or more sensors 112 can be optical sensors that can detect or recognize obstructions or sensitive components in the work piece. The one or more sensors 112 can be coupled with a control system 150 to provide a signal to the robotic cleaner 100 indicating the obstruction or sensitive component is present. The control system 150 can direct the robotic cleaner 100 away from the obstacle or sensitive component. The one or more sensors 112 can be coupled with the robotic cleaner body 101 at desired locations. For example, one or more sensors 112 can be coupled with a perimeter portion of the robotic cleaning frame 102. In another example, the control system 150 is coupled with at least one of the one or more motive elements 120. In yet another example, the control system 150 is coupled with a top surface 109 of the robotic cleaner body 101.

The control system 150 can be housed within the robotic cleaner body 101 and provide signals to the one or more motive elements 120 to maneuver the robotic cleaner 100 through the internal structures of the work piece. The control system 150 can autonomously and maneuver through the internal structures without direction from a user. In an example, the control system 150 can cause the robotic cleaner 100 to maneuver through the internal structures until it reaches a completion signal or notification. The robotic cleaner 100 can then drive to a portal, such as portal 210 of FIG. 2, through which the robotic cleaner 100 can be retrieved by the user.

In another example, the control system 150 is in communication with a remote control external to the work piece. A user can operate the robotic cleaner 100 via a remote control to direct the robotic cleaner 100 through the internal structures. For example, the control system 150 is in wireless communication with the remote control and receives signals from the remote control. The control system 150 can convert the signals from the remote controls to signals to provide direction instructions to maneuver the robotic cleaner 100 through the internal structures to clean the internal structures.

In an example, the robotic cleaner 100 includes one or more cleaning elements 110. The one or more cleaning elements 110 can be coupled with the robotic cleaning body 101 such as the robotic cleaning frame 102. For example, the one or more cleaning elements 110 can be coupled with the robotic cleaning frame 102 at one or more locations. The one or more cleaning elements 110 can be coupled with the robotic cleaning frame 102 at positions where the one or more cleaning elements 110 can contact surfaces that can be cleaned, such as the floor, within the internal structures of the work piece. In one example, the one or more cleaning elements 110 are coupled with the one or more motive elements 120. In another example, the one or more cleaning elements 110 are coupled with an undercarriage portion 107 of the robotic cleaning frame 102. In yet another example, the one or more cleaning elements 110 are coupled with the first side portion 103 or the second side portion 105. The one or more cleaning elements 110 can also be coupled with a combination of locations discussed herein relative to the robotic cleaning frame 102.

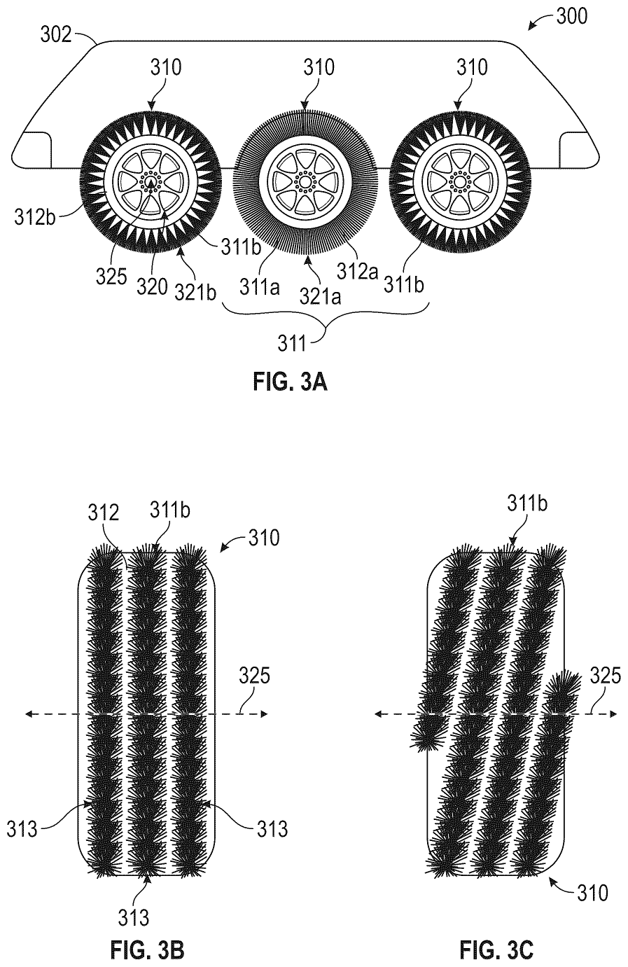

Illustrated in FIG. 3A is an example of a robotic cleaner 300 includes a robotic cleaning frame 302 and one or more cleaning elements 310 coupled with the robotic cleaner frame 302. The one or more cleaning elements 310 can include a debris collecting substrate 311. The debris collecting substrate 311 can be a material that can collect or retain debris that the robotic cleaner 300 comes into contact with when operating in the internal structures of the work piece. For example, the debris collecting substrate 311 can pick up debris because of the texture of the debris collecting substrate 311, or a static charge of the fabric, or due to an adhesive quality of the debris collecting substrate 311. For instance, the debris collecting substrate 311 includes bristles, cloth, fabric, adhesive sheets, a combination of materials or the like. In some examples the debris collecting substrate 311 is coupled with the one or more motive elements 320 but does not impede movement of the robotic cleaner 300. For instance, the debris collecting substrate 311 are coupled to rotatable members, such as wheels.

In some examples, the debris collecting substrate 311 includes a fabric 311a coupled with the one or more motive elements 320. For instance, the fabric 311a includes a microfiber fabric. Optionally, the fabric can include polyesters, polypropylenes, or a combination of materials. In other examples, the fabric can include fleece, wool, flannel or the like. The fabric 311a selected can retain debris gathered because of a static charge attracting the debris to the fabric 311a.

In an example, the debris collecting substrate 311 includes bristles 311b coupled with the one or more motive elements 320. For instance, the bristles 311b extend from the one or more motive elements 320 or are adhered to the one or more motive elements 320 or are otherwise coupled with the one or more motive elements 320. In another example, the bristles 311b are coupled with an intermediary material and the intermediary material is coupled with the one or more motive elements 320.

The bristles 311b can be arranged in one or more rows 313 along an outer surface 312 of at least one of the one or more motive elements 320. As illustrated in FIG. 3B, the one or more rows 313 can be arranged in substantially parallel row that extend substantially parallel with an axis of rotation 325 of at least one of the one or more motive elements 320. In another example, as illustrated in FIG. 3C, the bristles 311b are angled askew to the axis of rotation 325.

Optionally, the robotic cleaner 300 includes a first motive element 321a and a second motive element 321b. Each of the one or more motive elements 320 can be rotatable members. For example, each of the first motive element 321a and second motive element 321b can have a debris collecting substrate 311. The first motive element 321a can have fabric 311a coupled to the outer surface 312a. For instance, the fabric 311a can surround (e.g., completely, partially or a small portion relative to an outer surface of each of the one or more motive elements 320) one of the one or more motive elements 320. The second motive element 321b can have bristles 311b coupled to the outer surface 312b. The rows of bristles 311b coupled with the second motive element 321b can be angled towards the first motive element 321a. In another example, the bristles 311b are arranged in rows with the rows askew to the axis of rotation 325.

In an example, the bristles 311b can collect (e.g., gather, pick up, grasp or the like) debris encountered during operation. The bristles 311b, in some instances, can collects the debris but does not retain (e.g., hold, possess, contain or the like) all of the debris. The bristles 311b angled towards the fabric 311a can transfer loose debris collected by the bristles 311b to the fabric 311a. In an example, the fabric 311a retains (e.g., hold, possess, contain or the like) the transferred debris.

The one or more cleaning elements 310 can be removable from the robotic cleaning frame 302. In an example, the one or more cleaning elements 310 include the debris collecting substrate 311 coupled to the one or more motive elements 320. The one or more motive elements 320, including the one or more cleaning elements 310, can be removable from the robotic cleaning frame 302. The one or more cleaning elements 310 coupled to the robotic cleaning frame 302 or the one or more motive elements 320 can be removable to have the debris removed, or cleaned, from the one or more cleaning elements 310. The one or more cleaning elements 310 can be replaced on the robotic cleaning frame 302.

Returning to FIG. 1, the robotic cleaner 100 can include the power source 104. The power source 104 can provide power to the robotic cleaner 100 to move the robotic cleaner 100 through the internal structures, discussed previously related to FIG. 2, of the work piece. The power source 104 can be housed within the robotic cleaner body 101 or positioned within the robotic cleaning frame 102 or relative to the robotic cleaning frame 102. The power source 104 can be positioned relative to the cleaning frame 102 to not interfere with a debris collection operation of the one or more cleaning elements 110, 310.

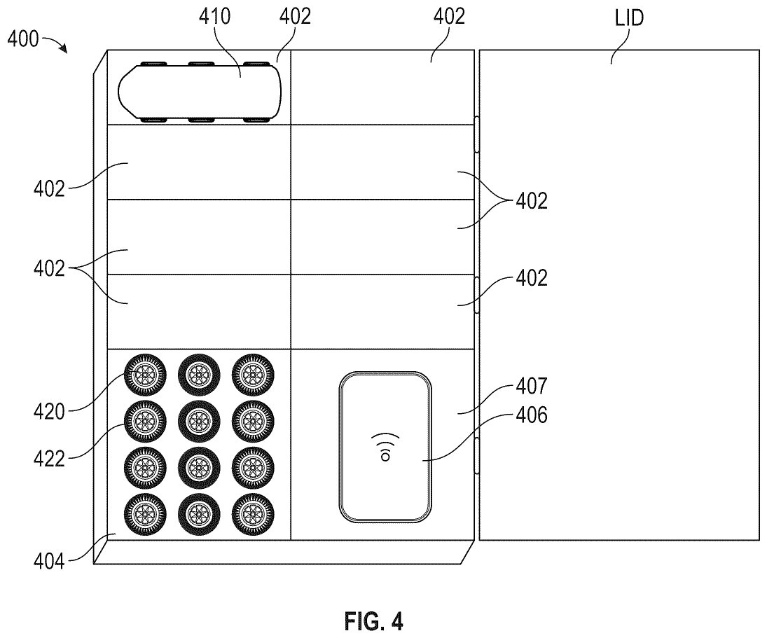

The power source 104 (of FIG. 1) of the robotic cleaner 100, 300, in some examples, is rechargeable. For instance, a system for removing debris from one or more internal structures of a work piece (such as work piece 200) can include both the robotic cleaner 100, 300 and a charging structure 400, as illustrated in FIG. 4. The charging structure 400 can also be a storage case for holding (e.g., storing, retaining) a robotic cleaner 410 without having a charging capability. The charging structure 400 can have one or more robotic cleaner compartments 402 sized and shaped to securely hold a robotic cleaner 410 (such as robotic cleaner 100, 300). In another examples, the one or more robotic cleaner compartments 402 holds more than one robotic cleaner 410. In an example, each of the one or more robotic cleaner compartments 402 has charging capabilities.

In an example, the one or more robotic cleaner compartments 402 includes plugs, electromagnetic induction or other connections that can be coupled with an external power source 406 provide additional power to the robotic cleaner 410. Each of the one or more robotic cleaner compartments 402 can have charging capabilities or the one or more robotic cleaner compartments 402 can be interconnected to provide charging capabilities to the one or more robotic cleaner 410. In another example, the robotic cleaner 410 is charged in a charging compartment 407. The charging compartment 407 can include a power source 406 such as a battery, plugs, cables or a wireless charger.

The charging structure 400 optionally includes one or more component compartments 404. The one or more component compartments 404 can hold extra or replacement components for the robotic cleaner 410. For example, the one or more component compartments 404 holds extra one or more motive elements 420 or one or more cleaning elements 422.

Optionally, the charging structure 400 is a portable charging structure that can be relocated according to the location of the work piece. In some examples, the robotic cleaner 410 can be used in work pieces that are at different locations. A charging structure 400 that is portable allows a user the option to reuse the robotic cleaner 410.

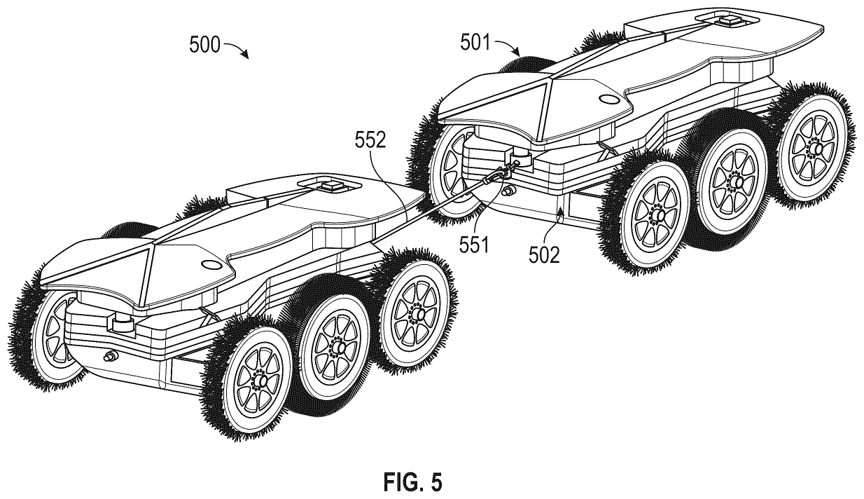

FIG. 5 illustrates a retrieval system that can include at least two robotic cleaners that can operate jointly in a situation when one of the robotic cleaners malfunctions or becomes inoperable. For example, the system for removing debris from one or more internal structures of a work piece (such as work piece 200) can include one or more robotic cleaners 100, 300. For example, one robotic cleaner is a cleaner as discussed related to FIG. 1 or 3A and another robotic cleaner is a supportive cleaner 501. For instance, the robotic cleaner 100, 300 malfunctions or becomes inoperable. The robotic cleaner 100, 300 can run out of power, can become stranded within the internal structure or become unable to operate as desired. In a system with one or more robotic cleaners 100, 300, a supportive robotic cleaner can be enabled to retrieve the malfunctioning robotic cleaner 100, 300.

In an example, the supportive robotic cleaner 501 can include a capture structure 551 coupled with the robotic cleaning frame 502. The capture structure 551 can be a hook, a loop, an adhesive, or other engaging feature that can be connected with a corresponding retrieval structure 552 on the inoperable robotic cleaner 500. In an example where a magnet would not affect the work piece, the capture structure can include a magnet. The corresponding retrieval structure 552 can be secured to the capture structure 551. The supportive robotic cleaner 501 can then pull, push or otherwise maneuver the inoperable robotic cleaner 500 towards the portal in the work piece. Jointly, the supportive robotic cleaner 501 and the inoperable robotic cleaner 500 can be removed from the work piece.

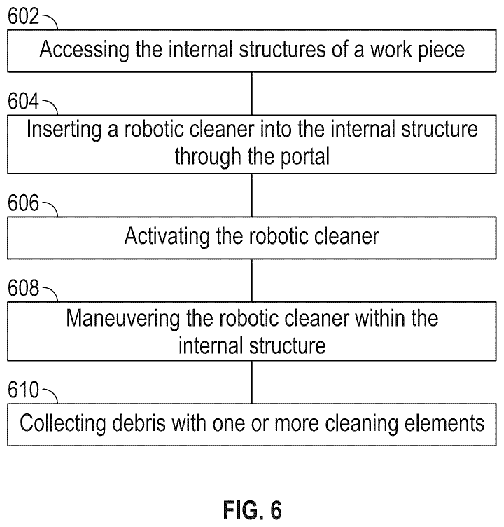

FIG. 6 illustrates a flow chart of a method of cleaning an internal structure of a work piece. For example, a method of cleaning an internal structure of a work piece, such as the internal structures of an electronic system, vehicle, defense system, computer system or the like, includes accessing the internal structures of the work piece through, for example, a portal at 602. The portal can be a door, window or the like that can protect the internal structures and internal components. The portal can be opened by a user for the user to gain access to the internal structures, such as pathways, channels, tunnels, cavities, spaces or the like. The portal can have a dimension or profile that is suitable for a robotic cleaner to fit through. In some examples, the portal can be less then approximately 50 centimeters in at least one dimension. In other examples, the portal can be less than approximately 25 centimeters. In yet another example, the portal can be less than approximately 10 centimeters.

The user can prepare the one or more cleaning element on the robotic cleaner, such as the brush, cloth, fabric or the like before inserting the robotic cleaner into the internal structure. Preparation of the one or more cleaning elements can include moistening, such as by spraying or applying water or other liquid, the one or more cleaning elements. Moistening the one or more cleaning elements can increase the attractiveness of debris. The user can insert one or more robotic cleaner into the internal structure of the work piece through the portal at 604. The user can insert as many robotic cleaners as desired to perform the cleaning task. The user can also insert a supportive robotic cleaner, if necessary, to retrieve inoperable robotic cleaners through the portal.

The robotic cleaner can be activated once inserted into the internal structures at 606. In another example, the robotic cleaner can be activated before being inserted into the internal structures.

Activating the robotic cleaner can cause the robotic cleaner to maneuver through the internal structures to clean, such as to collect debris, from the internal structures at 608. The robotic cleaner can maneuver through the internal structures autonomously or by a remote control. As the robotic cleaner maneuvers through the internal structures, it can travel along the internal structures cleaning the desired surfaces (e.g., floor, walls, ceiling). The robotic cleaner can travel along the internal structures until it recognizes or detects an obstacle such as a wall, sensitive component (e.g., electronics, supportive structures, wires, cables, or the like), or other substance (e.g., water, oil, chemicals) that the robotic cleaner should avoid. A control system or the user via a remote control can then direct the robotic cleaner away from the obstacle.

The robotic cleaner can then collect debris such as dust, dirt, droppings, particulates or liquids that are desired to be removed from the internal structures at 610. The robotic cleaner can collect the debris with one or more cleaning elements such as bristles, fabric, adhesive material or the like. The robotic cleaner can retain the debris within the cleaning elements until the robotic cleaner is removed from the work piece. In another example, the one or more cleaning elements can transfer the debris to a second cleaning element and the second cleaning element can retain the debris until the robotic cleaner is removed from the work piece.

In an example, when the robotic cleaner completes its cleaning operation, the robotic cleaner can return back to the portal and be removed from the portal. The user optionally removes the one or more cleaning elements from the robotic cleaner to remove the collected or retained debris.

### ASPECTS

Aspect 1 can include subject matter such as a system for removing debris from one or more internal structures of a work piece, the system comprising: One or more robotic cleaners sized to fit within the one or more internal structures, each of the one or more robotic cleaners including: a robotic cleaner frame; two or more rotatable members coupled with the robotic cleaner frame, each of the two or more rotatable members configured to move each of one or more robotic cleaners; and a debris collecting substrate coupled with at least one of the two or more rotatable members; wherein the debris collecting substrate is configured to perform a debris collecting operation; and a charging structure configured to provide power for each of the one or more robotic cleaners; wherein the charging structure is configured to recharge a battery of the one or more robotic cleaners.

Aspect 2 can include, or can optionally be combined with the subject matter of Aspect 1, to optionally include the work piece including: a chassis with one or more access portal; wherein the one or more access portal includes a door, window or panel for access to the one or more internal structures.

Aspect 3 can include, or can optionally be combined with the subject matter of one or any combination of Aspects 1 or 2 to optionally include at least one of the one or more robotic cleaners is autonomous.

Aspect 4 can include, or can optionally be combined with the subject matter of one or any combination of Aspects 1 to 3 to optionally include at least one of the one or more robotic cleaners includes one or more sensors.

Aspect 5 can include, or can optionally be combined with the subject matter of one or any combination of Aspects 1 to 4 to optionally include at least one of the two or more rotatable members are motive members.

Aspect 6 can include, or can optionally be combined with the subject matter of one or any combination of Aspects 1 to 5 to optionally include the debris collecting substrate includes bristles.

Aspect 7 can include, or can optionally be combined with the subject matter of one or any combination of Aspects 1 to 6 to optionally include a first rotatable member and a second rotatable member positioned on a first side of the robotic cleaner frame; wherein at least one of the first rotatable member and the second rotatable member is a motive member; a first debris collecting substrate coupled with the first rotatable member, the first debris collecting substrate including bristles; and a second debris collecting substrate coupled with the second rotatable member, the second debris collecting substrate including a fabric.

Aspect 8 can include, or can optionally be combined with the subject matter of one or any combination of Aspects 1 to 7 to optionally include at least one of the two or more rotatable members is configured to be removed from the robotic cleaner frame.

Aspect 9 can include, or can optionally be combined with the subject matter of one or any combination of Aspects 1 to 8 to optionally include the charging structure is configured to charge two or more robotic cleaners.

Aspect 10 can include subject matter such as a robotic cleaner for cleaning internal structures of a work piece, the work piece having internal structures surrounded by an enclosure having one or more access portals, the robotic cleaner comprising: a robotic cleaner body configured to be inserted into the work piece through the one or more access portals, the robotic cleaner body including: a robotic cleaner frame; one or more motive elements coupled with the robotic cleaner frame; and one or more cleaning elements coupled with the robotic cleaner frame, each cleaning element including: a debris collecting substrate configured to collect debris from the internal structures.

Aspect 11 can include, or can optionally be combined with the subject matter of one or any combination of Aspect 10 to optionally include the one or more motive elements includes the one or more cleaning elements.

Aspect 12 can include, or can optionally be combined with the subject matter of one or any combination of Aspects 10 or 11 to optionally include the debris collecting substrate includes bristles or a fabric.

Aspect 13 can include, or can optionally be combined with the subject matter of one or any combination of Aspects 10 to 12 to optionally include the robotic cleaner is autonomous, the robotic cleaner including one or more optical sensors.

Aspect 14 can include, or can optionally be combined with the subject matter of one or any combination of Aspects 10 to 13 to optionally include a first motive element and a second motive element; wherein each of the first motive element and the second motive element includes at least one of the one or more cleaning elements; wherein at least one of the one or more cleaning elements includes bristles configured to transfer collected debris from the bristles to the one or more cleaning elements of the second motive element.

Aspect 15 can include, or can optionally be combined with the subject matter of one or any combination of Aspects 10 to 14 to optionally include at least one of the one or more cleaning elements is removable.

Aspect 16 can include, or can optionally be combined with the subject matter of one or any combination of Aspects 10 to 15 to optionally include the robotic cleaner is remote controlled, the robotic cleaner including: a capture structure coupled to the robotic cleaner frame.

Aspect 17 can include subject matter such as a method of removing debris from an internal structure of a work piece, the method comprising: accessing the internal structure of the work piece through a portal; inserting a robotic cleaner into the internal structure through the portal; wherein the robotic cleaner includes a robotic cleaner frame and one or more motive members; activating the robotic cleaner; maneuvering the robotic cleaner within the internal structure; and while maneuvering, collecting debris with one or more cleaning elements coupled with the robotic cleaner frame of the robotic cleaner from the internal structure.

Aspect 18 can include, or can optionally be combined with the subject matter of one or any combination of Aspect 17 to optionally include the one or more cleaning elements are coupled with at least one of the one or more motive members; wherein at least one of the one or more cleaning elements includes bristles or a fabric.

Aspect 19 can include, or can optionally be combined with the subject matter of one or any combination of Aspects 17 or 18 to optionally include the work piece is an electronic system.

Aspect 20 can include, or can optionally be combined with the subject matter of one or any combination of Aspects 17 to 19 to optionally include the robotic cleaner is autonomous, the method including: recognizing an obstruction within the internal structure with at least one sensor coupled to the robotic cleaner; and maneuvering away from the obstruction.

The above description includes references to the accompanying drawings, which form a part of the detailed description. The drawings show, by way of illustration, specific embodiments in which the disclosed concepts can be practiced. These embodiments are also referred to herein as “aspects” or “examples.” Such aspects or example can include elements in addition to those shown or described. However, the description also contemplates aspects or examples in which only those elements shown or described are provided. Moreover, the description also contemplates aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel,” “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the disclosed concepts should be determined with reference to the appended claims, along with the full scope of equivalents to which such claims are entitled.

What is claimed is:

1. A system for removing debris from one or more internal structures of a work piece, the system comprising:
one or more robotic cleaners sized to fit within the one or more internal structures, each of the one or more robotic cleaners including:
a robotic cleaner frame;
two or more rotatable members coupled with the robotic cleaner frame, each of the two or more rotatable members configured to move each of one or more robotic cleaners; and
a debris collecting substrate coupled with at least one of the two or more rotatable members;
wherein the debris collecting substrate is configured to perform a debris collecting operation; and
a charging structure configured to provide power for each of the one or more robotic cleaners;
wherein the charging structure is configured to recharge a battery of the one or more robotic cleaners.

2. The system for removing debris of claim 1, including the work piece including:
a chassis with one or more access portal;
wherein the one or more access portal includes a door, window or panel for access to the one or more internal structures.

3. The system for removing debris of claim 1, wherein at least one of the one or more robotic cleaners is autonomous.

4. The system for removing debris of claim 1, wherein at least one of the one or more robotic cleaners includes one or more sensors.

5. The system for removing debris of claim 1, wherein at least one of the two or more rotatable members are motive members.

6. The system for removing debris of claim 1, wherein the debris collecting substrate includes bristles.

7. The system for removing debris of claim 1, including:
a first rotatable member and a second rotatable member positioned on a first side of the robotic cleaner frame;
wherein at least one of the first rotatable member and the second rotatable member is a motive member;
a first debris collecting substrate coupled with the first rotatable member, the first debris collecting substrate including bristles; and
a second debris collecting substrate coupled with the second rotatable member, the second debris collecting substrate including a fabric.

8. The system for removing debris of claim 1, wherein at least one of the two or more rotatable members is configured to be removed from the robotic cleaner frame.

9. The system for removing debris of claim 1, wherein the charging structure is configured to charge two or more robotic cleaners.

10. A robotic cleaner for cleaning internal structures of a work piece, the work piece having internal structures surrounded by an enclosure having one or more access portals, the robotic cleaner comprising:
a robotic cleaner body configured to be inserted into the work piece through the one or more access portals, the robotic cleaner body including:
a robotic cleaner frame;
one or more motive elements coupled with the robotic cleaner frame; and
one or more cleaning elements coupled with the robotic cleaner frame, each cleaning element including:
a debris collecting substrate configured to collect debris from the internal structures.

11. The robotic cleaner of claim 10, wherein the one or more motive elements includes the one or more cleaning elements.

12. The robotic cleaner of claim 10, wherein the debris collecting substrate includes bristles or a fabric.

13. The robotic cleaner of claim 10, wherein the robotic cleaner is autonomous, the robotic cleaner including one or more optical sensors.

14. The robotic cleaner of claim 10, including:
a first motive element and a second motive element;
wherein each of the first motive element and the second motive element includes at least one of the one or more cleaning elements;
wherein at least one of the one or more cleaning elements includes bristles configured to transfer collected debris from the bristles to the one or more cleaning elements of the second motive element.

15. The robotic cleaner of claim 10, wherein at least one of the one or more cleaning elements is removable.

16. The robotic cleaner of claim 10, wherein the robotic cleaner is remote controlled, the robotic cleaner including:
a capture structure coupled to the robotic cleaner frame.

17. A method of removing debris from an internal structure of a work piece, the method comprising:
accessing the internal structure of the work piece through a portal;
inserting a robotic cleaner into the internal structure through the portal;
wherein the robotic cleaner includes a robotic cleaner frame and one or more motive members;
activating the robotic cleaner;
maneuvering the robotic cleaner within the internal structure; and
while maneuvering, collecting debris with one or more cleaning elements coupled with the robotic cleaner frame of the robotic cleaner from the internal structure.

18. The method of removing debris of claim 17, wherein the one or more cleaning elements are coupled with at least one of the one or more motive members;
wherein at least one of the one or more cleaning elements includes bristles or a fabric.

19. The method of removing debris of claim 17, wherein the work piece is an electronic system.

20. The method of removing debris of claim 17, wherein the robotic cleaner is autonomous, the method including:
recognizing an obstruction within the internal structure with at least one sensor coupled to the robotic cleaner; and
maneuvering away from the obstruction.
